(19) United States
(12) Patent Application Publication
(10) Pub. No.: US 2010/0134936 A1
(43) Pub. Date: Jun. 3, 2010

(54) CIRCUIT FOR PROTECTING ELECTRICAL AND/OR ELECTRONIC SYSTEM BY USING ABRUPT METAL-INSULATOR TRANSITION DEVICE AND ELECTRICAL AND/OR ELECTRONIC SYSTEM COMPRISING THE CIRCUIT

(75) Inventors: Hyun-Tak Kim, Daejeon-city (KR); Kwang-Yong Kang, Daejeon-city (KR); Byung-Gyu Chae, Daejeon-city (KR); Bong-jun Kim, Daejeon-city (KR); Sun-jin Yun, Daejeon-city (KR); Yong-wook Lee, Daejeon-city (KR); Gyung-Ock Kim, Seoul (KR); Doo-Hyeb Youn, Daejeon-city (KR); Jung-Wook Lim, Daejeon-city (KR)

Correspondence Address: Jae Y. Park, Kile, Goekjian, Reed & McManus, PLLC, 1200 New Hampshire Ave. NW, Suite 570, Washington, DC, 20036, US

(73) Assignee: Electronics and Telecommunications Research Instit, Daejeon (KR)

(21) Appl. No.: 11/816,732

(22) PCT Filed: Feb. 17, 2006
(86) PCT No.: PCT/KR2006/000542

§ 371 Date: Aug. 21, 2007

(30) Foreign Application Priority Data
Feb. 21, 2005 (KR) 10-2005-0014228
Jun. 16, 2005 (KR) 10-2005-0051982
Nov. 22, 2005 (KR) 10-2005-0111882

(51) Int. Cl. H02H 9/04; H02H 9/00

(52) U.S. Cl. 361/56; 361/54

(57) ABSTRACT

Provided are an electrical and/or electronic system protecting circuit using an abrupt metal-insulator transition (MIT) device which can effectively remove high-frequency noise with a voltage greater than a rated standard voltage received via a power line or a signal line of an electrical and/or electronic system, and the electrical and/or electronic system including the electrical and/or electronic system protecting circuit. The abrupt MIT device of the electrical and/or electronic system protecting circuit abrupt is connected in parallel to the electrical and/or electronic system to be protected from the noise. The electrical and/or electronic system protecting circuit bypasses toward the abrupt MIT device most of the noise current generated when the voltage greater than the rated standard voltage is applied, thereby protecting the electrical and/or electronic system.

### CROSS-REFERENCE TO RELATED PATENT APPLICATIONS

This application claims the benefit of Korean Patent Application Nos. 10-2005-0014228, filed on Feb. 21, 2005, and 10-2005-0051982, filed on Jun. 16, 2005 and 10-2005-0111882 filed on 22 Nov. 2005 in the Korean Intellectual Property Office, the disclosures of which are incorporated herein in its entirety by reference.

### BACKGROUND OF THE INVENTION

1. Field of the Invention

The present invention relates to a circuit for protecting an electrical and/or electronic system, and more particularly, to a circuit for protecting electronic components included in an electrical and/or electronic system from an external high-voltage high-frequency noise signal or static electricity.

2. Description of the Related Art

Noise that affects electronic components flows in through a power line that supplies power to an electric and electronic system and a signal line that receives and outputs an electrical signal from and to the electric and electronic system. Accordingly, an electrical and/or electronic system protecting circuit is installed between the power line and an internal electronic component or between the signal line and the internal electronic component. The electrical and/or electronic system protecting circuit is so important as to say that the electrical and/or electronic system protecting circuit is required by almost all electronic products.

Low-voltage noise signals coming via a power line or a signal line are generally blocked by a noise signal removing filter included in an electrical and/or electronic system protecting circuit. On the other hand, it is known that high-voltage power noise is removed by a varistor which is a semiconductor resisting element formed of ZnO. When a high voltage or large current is applied to the varistor, the electrical characteristics of the varistor change. In other words, when a voltage dropping from, the varistor is high or much current flow in the varistor, high heat is generated. The electrical characteristics of the varistor are changed by the heat so that the varistor turns into a low resistor. The varistor having the characteristics of a resistor in that its resistance value changes according to a voltage value of a received signal can reduce a received surge noise signal.

When the electrical and/or electronic system is installed in a place where a motor exists or in a place where static electricity or a high-voltage electromagnetic wave exists, the possibility that high-frequency noise with a high voltage larger than a rated standard voltage is received via the power line and/or signal line of the electrical and/or electronic system cannot be excluded. The varistor is remarkably good at blocking the low-frequency noise signal with a high voltage but is poor at blocking a high-voltage, high-frequency noise signal. This fact is due to the physical characteristics of the varistor.

However, the thing that destroys most of electrical and/or electronic systems or their internal electronic components is high-voltage high-frequency noise having several mega hertz (MHz) or greater or an instantaneous high voltage, such as, static electricity.

To protect electronic components from unwanted signals, such as, such high-voltage, high-frequency noise signals and static electricity, a constant voltage protecting apparatus, such as, an inverter surge filter, has been proposed. The inverter surge filter can be manufactured by adequately combining a low pass filter with a high pass filter. Each of the low pass filter and the high pass filter may be made up of a resistor, an inductor, and a capacitor. However, it is not simple to form such an inverter surge filter having predetermined electrical characteristics, and the formation requires a high cost. In addition, although the inverter surge filter is installed in an electrical and/or electronic system, if an incoming noise signal has a high frequency and a high voltage, the security of the electrical and/or electronic system cannot be 100% guaranteed:

A noise signal having a high voltage and a high-frequency component may stop an operation of a microprocessor installed within an electrical and/or electronic system. The interruption of the operation of the microprocessor can may not occur by using a watch dog that always monitors an operational state of the microprocessor. However, the use of such a watch dog requires high costs regardless of whether the monitoring is achieved using software or hardware.

As described above, a conventional protecting circuit cannot protect internal electronic components from a received high-voltage, high-frequency noise signal and requires high costs to achieve protection.

### SUMMARY OF THE INVENTION

The present invention provides a circuit and method of protecting an electrical and/or electronic system, by which when high-frequency noise with a high voltage, that is, a voltage greater than a rated standard voltage, flows into the electrical and/or electronic system via a power line or a signal line, the noise can be effectively removed. Here, the noise denotes any noise that can cause the electrical and/or electronic system to disorder while having a voltage greater than the rated standard voltage. Examples of the noise include lightning, high-voltage discharge, etc.

According to an aspect of the present invention, there is provided an electrical and/or electronic system protecting circuit comprising an abrupt metal-insulator transition (MIT) device connected in parallel to an electrical and/or electronic system to be protected from noise.

Electrical characteristics of the abrupt metal-insulator transition device abruptly change according to a voltage level of the noise. That is, the abrupt metal-insulator transition device has a characteristic of an insulator below a predetermined limit voltage and has a characteristic of a metal at or over the limit voltage.

The abrupt metal-insulator transition device is connected in parallel to a power voltage source which supplies the power voltage to the electrical and/or electronic system or to a signal source which supplies the signal to the electrical and/or electronic system. The abrupt metal-insulator transition device is connected to the power voltage source or the signal source via a protecting resistor which protects the abrupt metal-insulator transition device. The electrical and/or electronic system protecting circuit further includes a power voltage reinforcing capacitor connected in parallel to the power voltage source or the signal source.

According to another aspect of the present invention, there is provided an electrical and/or electronic system protecting circuit comprising an abrupt metal-insulator transition device that is connected in parallel to an electrical and/or electronic system to be protected from noise and includes an abrupt metal-insulator transition thin film containing low-concentration holes and a first electrode thin film and a second electrode thin film that contact the abrupt metal-insulator transition thin film.

The abrupt MIT device may have either a stacked structure or a planar-type structure according to the locations of a transition thin film, a first electrode thin film, and a second electrode thin film. The abrupt metal-insulator transition thin film may be formed of at least one material selected from the group consisting of an inorganic semiconductor to which low-concentration holes are added, an inorganic insulator to which low-concentration holes are added, an organic semiconductor to which low-concentration holes are added, an organic insulator to which low-concentration holes are added, a semiconductor to which low-concentration holes are added, an oxide semiconductor to which low-concentration holes are added, and an oxide insulator to which low-concentration holes are added, wherein the above-described materials each include at least one of oxygen, carbon, a semiconductor element (i.e., groups III-V and groups II-IV), a transition metal element, a rare-earth element, and a lanthanum-based element.

Each of the first and second electrode thin films is formed of at least one material selected from the group consisting of W, Mo, W/Au, Mo/Au, Cr/Au, Ti/W, Ti/Al/N, Ni/Cr, Al/Au, Pt, Cr/Mo/Au, YB₂Cu₃O_{7-d}, Ni/Au, Ni/Mo, Ni/Mo/Au, Ni/Mo/Ag, Ni/Mo/Al, Ni/W, Ni/W/Au, Ni/W/Ag, and Ni/W/Al.

According to another aspect of the present invention, there is provided an electrical and/or electronic system, the system including a load electric and electronic system to be protected from noise and an electrical and/or electronic system protecting circuit including an abrupt metal-insulator transition (MIT) device connected in parallel to the load electrical and/or electronic system.

The electrical and/or electronic system may include a power voltage source which supplies the power voltage to the load electrical and/or electronic system or a signal source which supplies the signal to the load electrical and/or electronic system. The electrical and/or electronic system protecting circuit may further include at least one abrupt MIT device connected in parallel to the previous abrupt MIT device.

The attached drawings for illustrating preferred embodiments of the present invention are referred to in order to gain a sufficient understanding of the present invention, the merits thereof, and the objectives accomplished by the implementation of the present invention.

### BRIEF DESCRIPTION OF THE DRAWINGS

The above and other features and advantages of the present invention will become more apparent by describing in detail exemplary embodiments thereof with reference to the attached drawings in which:

FIG. 1 is a graph showing a current-voltage curve of an abrupt metal-insulator transition (MIT) device;

FIG. 2 is a vertical cross-section of an abrupt MIT device having a stacked structure;

FIG. 3 is a vertical cross-section of an abrupt MIT device having a planar-type structure;

FIG. 4 is a graph showing a current-voltage curve of an abrupt planar-type MIT device in which an abrupt MIT film is formed of a p-type GaAs thin film to which holes of a low concentration are added;

FIG. 5 is a picture of a micro X-ray diffraction pattern with respect to an abrupt MIT device in a case A of FIG. 4 where no voltages are applied;

FIG. 6 is a picture of a micro X-ray diffraction pattern with respect to an abrupt MIT device when a voltage indicated by arrow B is applied after an abrupt MIT as shown in FIG. 4;

FIG. 7 is a circuit diagram including an electrical and/or electronic system protecting circuit according to an embodiment of the present invention;

FIG. 8 is a circuit diagram including an electrical and/or electronic system protecting circuit according to another embodiment of the present invention;

FIG. 9 is a circuit diagram including an electrical and/or electronic system protecting circuit according to another embodiment of the present invention;

FIG. 10 is a circuit diagram including an electrical and/or electronic system protecting circuit according to another embodiment of the present invention;

FIG. 11 is a graph showing a relationship between a power voltage and a voltage dropping at a protecting resistor in the circuit of FIG. 10 before occurrence of an abrupt MIT when no equivalent load resistors exist.

FIG. 12 is a graph showing a relationship between a power voltage and a voltage dropping at the protecting resistor in the circuit of FIG. 10 after occurrence of an abrupt MIT when no equivalent load resistors exist;

FIG. 13 is a graph showing a relationship between a power voltage and a voltage dropping at the protecting resistor in the circuit of FIG. 10 before occurrence of an abrupt MIT when an equivalent load resistor with a 10 kΩ resistance is included;

FIG. 14 is a graph showing a relationship between a power voltage and a voltage dropping at the protecting resistor in the circuit of FIG. 10 after occurrence of an abrupt MIT when an equivalent load resistor with a 10 kΩ resistance is included; and

FIG. 15 is a graph showing a current-voltage curve obtained when no protecting resistors are included in the circuit of FIG. 10 and an equivalent load resistor exists in the circuit of FIG. 10 and a current-voltage curve obtained when no protecting resistors are included in the circuit of FIG. 10 and no equivalent load resistors exist in the circuit of FIG. 10.

### DETAILED DESCRIPTION OF THE INVENTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. In the drawings, the thicknesses of layers and regions are exaggerated for clarity. To facilitate understanding, identical reference numerals have been used, where possible, to designate identical elements that are common to the figures.

The present invention proposes an electrical and/or electronic system protecting circuit which removes static electricity or high-voltage high frequency noise from an electrical and/or electronic system by using a new medium whose electrical characteristics abruptly vary according to a voltage level of a received signal. The new medium is referred as a metal-insulator transition (MIT) device.

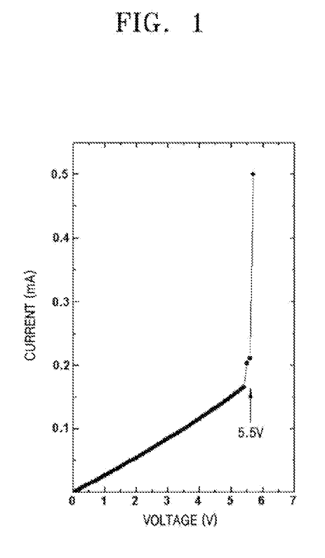

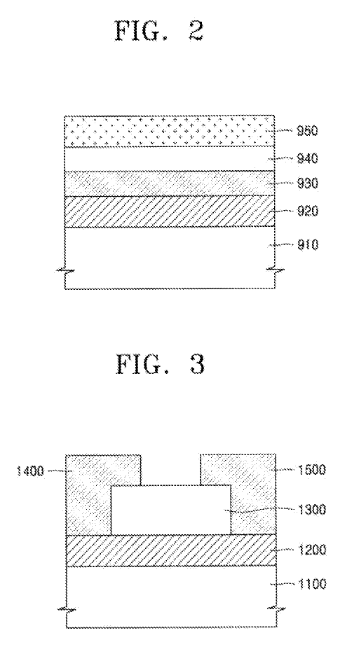

FIG. 1 is a graph showing a current-voltage curve of an abrupt MIT device. The abrupt MIT device of FIG. 1 includes an abrupt MIT thin film (hereinafter, referred to as a transition thin film) formed of vanadium oxide. Structures of the abrupt MIT device are shown in FIGS. 2 and 3. In FIG. 1, voltage expressed in the unit of V on the x axis denotes a voltage dropping at both ends of the abrupt MIT device, and current expressed in the unit of mA (mili-Ampere) on the y axis denotes current passing through the abrupt MIT device.

Referring to FIG. 1, the abrupt MIT device has a characteristic of an insulator in that little current flows between dropping voltages of 0V and about 5.5V. When the dropping voltage is about 5.5V or greater, the current discontinuously jumps, because an electrical characteristic of the abrupt MIT device transits from the insulator to a metallic material. A resistance of the abrupt MIT device can be known from the voltage-current curve of FIG. 1.

The transition of the electrical characteristic of the abrupt MIT device to the metallic material resulting in the discontinuous jump of current is described in some papers, namely, New J. Physics 6 (2004) 52; http//xxx.lanl.gov/abs/con-mat/041328; and Appl. Phys. Lett. 86 (2005) 242101, and U.S. Pat. No. 6,624,463 to the inventors of the present invention.

A voltage at which the electrical characteristic of an abrupt MIT device transits from an insulator to a metallic material is defined as a limit voltage. According to this definition, the limit voltage of the abrupt MIT device of FIG. 1 is about 5.5V. The limit voltage may vary according to the structures of components of the abrupt MIT device and the electrical characteristics of materials used to form the components.

An abrupt MIT device used in the present invention may have either a stacked (or vertical) structure or a planar-type structure according to the locations of a transition thin film, a first electrode thin film, and a second electrode thin film.

FIG. 2 is a vertical cross-section of an abrupt MIT device having a stacked structure. Referring to FIG. 2, the abrupt MIT device having a stacked structure includes a substrate 910, a buffer layer 920 formed on the substrate 910, and a first electrode thin film 930, a transition thin film 940, and a second electrode thin film 950 which are sequentially formed on the buffer layer 920.

The buffer layer 920 buffers a lattice mismatch between the substrate 910 and the first electrode thin film 930. When the lattice mismatch between the substrate 910 and the first electrode thin film 930 is very small, the first electrode thin film 930 may be formed directly on the substrate 910 without the buffer layer 920. The buffer layer 920 may include a SiO₂ or Si₃N₄ film.

Each of the first and second electrode thin films 930 and 950 is formed of at least one material of W, Mo, W/Au, Mo/Au, Cr/Au, Ti/W, Ti/Al/N, Ni/Cr, Al/Au, Pt, Cr/Mo/Au, YB₂Cu₃O_{7-d}, Ni/Au, Ni/Mo, Ni/Mo/Au, Ni/Mo/Ag, Ni/Mo/Al, Ni/W, Ni/W/Au, Ni/W/Ag, and Ni/W/Al. The substrate 910 is formed of at least one material of Si, SiO₂, GaAs, Al₂O₃, plastic, glass, V₂O₅, PrBa₂Cu₃O₇, YBa₂Cu₃O₇, MgO, SrTiO₃, Nb-doped SrTiO₃, and silicon-on-insulator (SOI).

FIG. 3 is a vertical cross-section of an abrupt MIT device having a planar-type structure. Referring to FIG. 3, the abrupt MIT device having a planar-type structure includes a substrate 1100, a buffer layer 1200 formed on the substrate 1100, a transition thin film 1300 formed on a part of the upper surface of the buffer layer 1200, and a first electrode thin film 1400 and a second electrode thin film 1500 which are formed on exposed portions of the buffer layer 1200 and on lateral surfaces and an upper surface of the transition thin film 1300 such as to face each other. In other words, the first and second electrode thin films 1400 and 1500 are separated from each other by the transition thin film 1300 formed therebetween.

The buffer layer 1200 buffers a lattice mismatch between the transition thin film 1300 and the substrate 1100. When the lattice mismatch between the substrate 1100 and the transition thin film 1300 is very small, the transition thin film 1300 may be formed directly on the substrate 1100 without the buffer layer 1220.

Of course, the buffer layer 1200, the first and second electrode thin films 1400 and 1500, and the substrate 1100 may be formed of the materials of the buffer layer 920, the first and second electrode thin films 930 and 950, and the substrate 910.

Although the electrical conductivities of the abrupt MIT devices change abruptly, the structures of the transition thin films 940 and 1300 do not change.

The electricity-voltage characteristics of the planar-type abrupt MIT device depending on the material of the transition thin film 1300 will now be described.

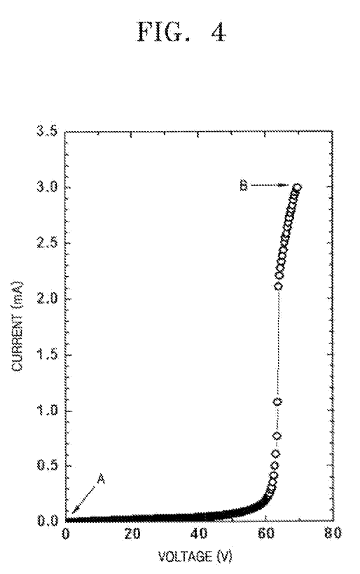

FIG. 4 is a graph showing a current-voltage curve of a planar-type abrupt MIT device in which a transition thin film is formed of a p-type GaAs thin film to which holes of a low concentration are added. Referring to FIG. 4, current flowing in the planar-type abrupt MIT device increases with an increase in a voltage applied between the first and second electrode thin films 1400 and 1500. The current abruptly increases around 60V and increases according to the Ohm's law over about 60V. By comparing X-ray diffraction patterns of the planar-type abrupt MIT device at locations A and B with each other, it is determined whether there is a difference between the structures of the abrupt MIT device before and after an abrupt MIT.

FIG. 5 is a picture of a micro X-ray diffraction pattern with respect to an abrupt MIT device in a case A of FIG. 4 where no voltages are applied. In other words, FIG. 5 is a picture of a micro X-ray diffraction pattern when 0V is applied to the abrupt MIT device.

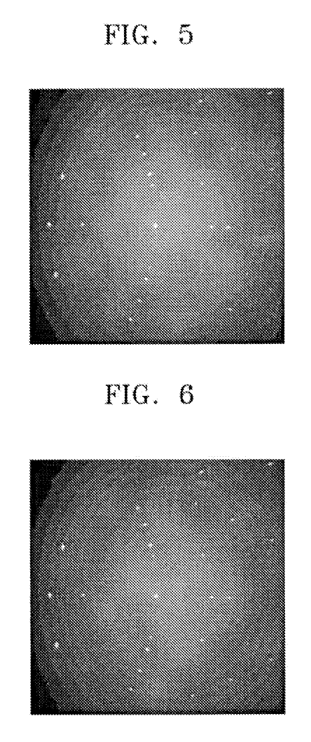

FIG. 6 is a picture of a micro X-ray diffraction pattern with respect to the abrupt MIT device in a case B of FIG. 4 where a voltage after an abrupt MIT is applied. As shown in FIG. 4, a voltage dropping through the abrupt MIT device is about 70V.

The diffraction patterns of FIGS. 5 and 6 are the same. This means that they have an identical structure. According to a steep inclination of the curve of FIG. 4, an MIT is considered abrupt. Referring to FIGS. 5 and 6, the structure of the abrupt MIT device did not change between before and after the abrupt MIT.

Such an abrupt MIT, that is, a fast switching operation, is achieved by the transition film of the abrupt MIT device. The transition film may be obtained by suitably adding low-concentration holes to an insulator. A mechanism for an abrupt MIT caused due to an addition of low-concentration holes to an insulator is disclosed in some papers, namely, New J. Phys. 6 (2004) 52 and http//xxx.lanl.gov/abs/cond-mat/0411328 and Appl. Phys. Lett. 86 (2005) 242101, and U.S. Pat. No. 6,624,463.

Each of the transition thin films 940 and 1300, which cause an abrupt MIT to occur in the abrupt MIT devices of FIGS. 2 and 3, may be formed of at least one material selected from the group consisting of a p-type inorganic semiconductor to which low-concentration holes are added, a p-type inorganic insulator to which low-concentration holes are added, a p-type organic semiconductor to which low-concentration holes are added, a p-type organic insulator to which low-concentration holes are added, a p-type semiconductor to which low-concentration holes are added, a p-type oxide semiconductor to which low-concentration holes are added, and a p-type oxide insulator to which low-concentration holes are added. Each of the aforementioned materials includes at least one of oxygen, carbon, a semiconductor element (i.e., groups III-V and groups II-IV), a transition metal element, a rare-earth element, and a lanthanum-based element. The transition thin films 940 and 1300 may also be formed of an n-type semiconductor-insulator having a very large resistance.

As described above, electrical and/or electronic system protecting circuits according to embodiments of the present invention to be described below use an abrupt MIT device whose electrical characteristics abruptly change according to the level of a dropping voltage. The abrupt MIT device is connected in parallel to a power voltage source or a signal source.

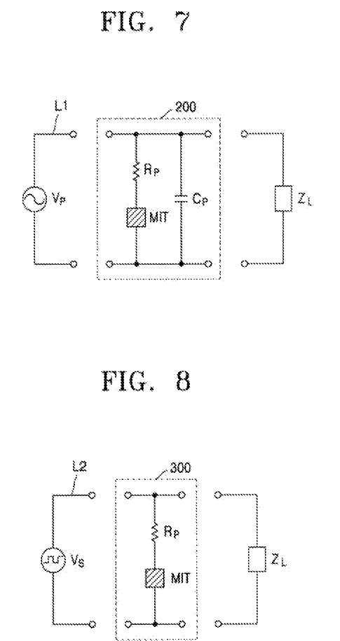

FIG. 7 is a circuit diagram including an electrical and/or electronic system protecting circuit 200 according to an embodiment of the present invention. Referring to FIG. 7, the electrical and/or electronic system protecting circuit 200 includes an abrupt MIT device MIT, a protecting resistor Rₚ, and a power voltage reinforcing capacitor Cₚ.

A load impedance Z_{L} is an equivalent impedance that corresponds to an electrical and/or electronic system and is used to verify the characteristics of the electrical and/or electronic system protecting circuit 200. Static electricity or high-voltage high-frequency noise may be applied via a power line L1 that applies a power voltage to the electrical and/or electronic system Z_{L}. The electrical and/or electronic system Z_{L} may be any electrical and/or electronic system as long as it needs to be protected from high-voltage high-frequency noise, such as, all sorts of electronic devices, electrical components, electronic systems, or high-voltage electrical systems.

The protecting resistor Rₚ is serially connected to the abrupt MIT device MIT and restricts a voltage or current applied to the abrupt MIT device MIT to protect the abrupt MIT device MIT. The protecting resistor Rₚ and the abrupt MIT device MIT as a whole are connected to a power voltage source Vₚ or the electrical and/or electronic system Z_{L} in parallel.

The power voltage reinforcing capacitor Cₚ prevents the voltage level of the power voltage source Vₚ from dropping to a rated standard voltage or less when an abrupt MIT occurs in the abrupt MIT device MIT. Hence, the power voltage reinforcing capacitor Cₚ and the power voltage source Vₚ should be connected to each other in parallel. Consequently, the power voltage reinforcing capacitor Cₚ should be connected to a line of the protecting resistor Rₚ and the abrupt MIT device MIT in parallel.

The electrical and/or electronic system protecting circuit 200 removes static electricity or high-voltage high-frequency noise applied to the electrical and/or electronic system Z_{L}, by using the abrupt MIT device MIT. In other words, when noise with a voltage equal to or greater than a predetermined voltage is applied to the electrical and/or electronic system, the abrupt MIT device MIT connected to the electrical and/or electronic system Z_{L} via the protecting resistor Rₚ in parallel generates abrupt MIT so that most of current flows through the abrupt MIT device MIT, thereby protecting the electrical and/or electronic system Z_{L}.

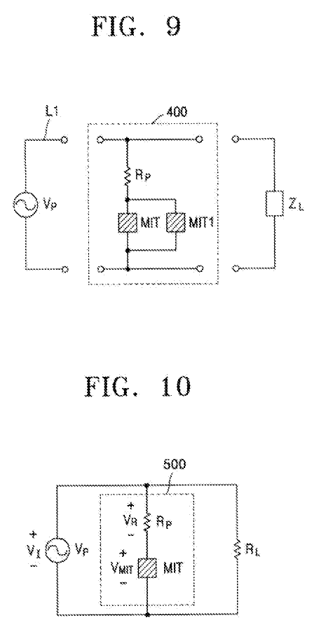

FIG. 8 is a circuit diagram including an electrical and/or electronic system protecting circuit 300 according to another embodiment of the present invention. Referring to FIG. 8, the electrical and/or electronic system protecting circuit 300 includes an abrupt MIT device MIT and a protecting resistor Rₚ. Similar to FIG. 7, the protecting resistor Rₚ is serially connected to the abrupt MIT device MIT, and the protecting resistor Rₚ and the abrupt MIT device MIT are connected to a signal source Vₛ or an electrical and/or electronic system Z_{L} in parallel. In this embodiment, since a signal received via the signal source Vₛ does not have a rated voltage, a capacitor as shown in the embodiment of FIG. 7 is not necessary.

In the embodiment of FIG. 8, when noise with a voltage equal to or greater than a predetermined voltage is applied to the electrical and/or electronic system Z_{L} via a signal line L2, most of current flows through the abrupt MIT device MIT, whereby the electrical and/or electronic system Z_{L} is protected.

FIG. 9 is a circuit diagram including an electrical and/or electronic system protecting circuit 400 according to another embodiment of the present invention. Referring to FIG. 9, the electrical and/or electronic system protecting circuit 400 includes a protecting resistor Rₚ, an abrupt MIT device MIT, and another abrupt MIT device MIT1 connected to the abrupt MIT device MIT in parallel. The current to flow through the abrupt MIT device MIT is shared with the abrupt MIT device MIT1, whereby the abrupt MIT devices MIT and MIT1 can be protected. Since the abrupt MIT devices MIT and MIT1 are connected to each other in parallel, the overall resistance decreases. Hence, the abrupt MIT devices MIT and MIT1 connected in parallel can substitute for an abrupt MIT device with a low resistance. Although one abrupt MIT device MIT1 is connected to the abrupt MIT device MIT in parallel in the embodiment of FIG. 9, more than one abrupt MIT device may be further connected to the abrupt MIT device MIT.

Since a power voltage source Vₚ is used in the embodiment of FIG. 9, a power voltage reinforcing capacitor as in the embodiment of FIG. 7 may be included in the electrical and/or electronic system protecting circuit 400. Even when a signal source as shown in the embodiment of FIG. 8 is used, the overall resistance of the abrupt MIT device MIT still can be reduced by further connecting at least one abrupt MIT device to the abrupt MIT device MIT in parallel.

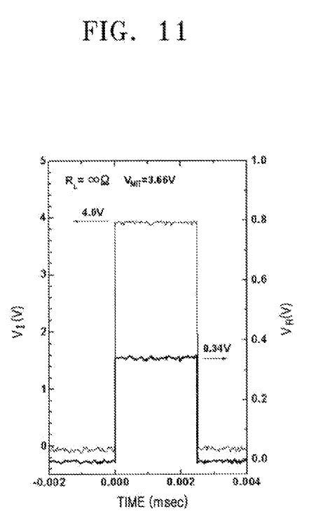

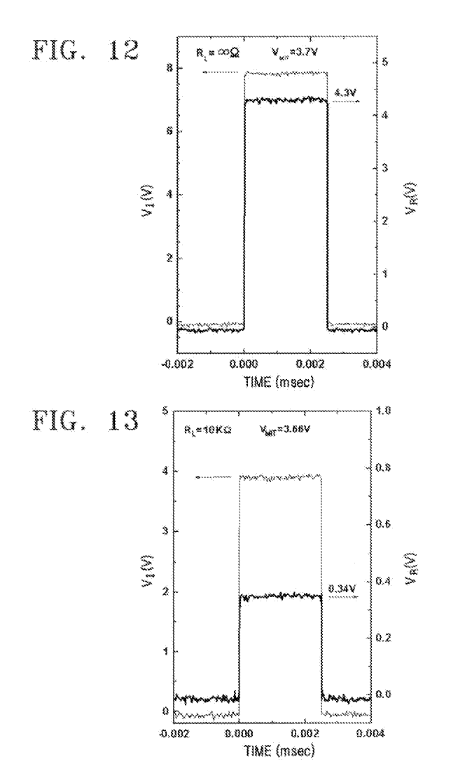

FIG. 10 illustrates a circuit including an electrical and/or electronic system protecting circuit 500 according to another embodiment of the present invention. FIGS. 11 through 15 are graphs showing electrical characteristics with respect to the circuit diagram of FIG. 10. Operating principles of the electrical and/or electronic system protecting circuits 200, 300, and 400 can be more accurately understood through the embodiment of FIG. 10.

Referring to FIG. 10, the circuit includes a power voltage source Vₚ, an abrupt MIT device MIT connected to the power voltage source Vₚ via a protecting resistor Rₚ in parallel, and an equivalent load resistor R_{L}. A voltage supplied from the power voltage source Vₚ (hereinafter, referred to a power voltage) is designated as V_{I}, a voltage dropping at the protecting resistor Rₚ is designated as V_{R}, and a voltage dropping at the abrupt MIT device MIT is designated as V_{MIT}. The resistance of the protecting resistor Rₚ is 3 kΩ. In contrast with the circuit of FIG. 7, the circuit of FIG. 10 does not include a power voltage reinforcing capacitor Cₚ, and the equivalent load resistor R_{L}, which is made up of only a resistor, replaces an equivalent impedance Z_{L}.

A relationship between the power voltage V_{I} and the voltage V_{R} of the circuit shown in FIG. 10 will now be described through an experiment. To ascertain the characteristics of the circuit of FIG. 10 when a load corresponding to an electrical and/or electronic system is not connected thereto, the resistance of the equivalent load resistor R_{L} was set to ∞Ω. The abrupt MIT device MIT used in the experiment was the transition thin film formed of vanadium oxide and having the characteristics shown in the graph of FIG. 1. Accordingly, the limit voltage was about 5.5V.

FIG. 11 is a graph showing a relationship between the power voltage V_{I} and the voltage V_{R} dropping at the protecting resistor Rₚ before occurrence of an abrupt MIT when the equivalent load resistor R_{L} in the circuit of FIG. 10 is ∞Ω. Referring to FIG. 11, when a power voltage V_{I} of 200 kHz and 4V (which is indicated by a thin line) is applied without the equivalent load resistor R_{L}, the voltage V_{R} dropping at the protecting resistor Rₚ (which is indicated by a thick line) is shown.

When the power voltage V_{I} of 200 kHz and 4V was applied, an abrupt MIT did not occur in the abrupt MIT device MIT, because the 4V power voltage V_{I} was lower than the 5.5V limit voltage of the abrupt MIT device MIT. In this case, the voltage V_{MIT} dropping at the abrupt MIT device MIT was 3.66V, and the voltage V_{R} dropping at the protecting resistor Rₚ was 0.34V. The resistance of the abrupt MIT device MIT was calculated to about 32 kΩ based on the above voltage values.

FIG. 12 is a graph showing a relationship between the power voltage V_{I} and the voltage V_{R} dropping at the protecting resistor Rₚ after occurrence of an abrupt MIT when the equivalent load resistor R_{L} in the circuit of FIG. 10 was ∞Ω. Referring to FIG. 12, when a power voltage V_{I} of 200 kHz and 8V was applied, an abrupt MIT occurred in the abrupt MIT device MIT, because the 8V power voltage V_{I} was greater than the 5.5V limit voltage of the abrupt MIT device MIT. When an abrupt MIT occurred, the abrupt MIT device MIT having a characteristic of an insulator and a significantly large resistance was changed to a metallic resistor having a predetermined low resistance. In this case, the voltage V_{R} dropping at the protecting resistor Rₚ was high, namely, 4.3V, and the voltage V_{MIT} dropping at the abrupt MIT device MIT was 3.7V. The resistance of the abrupt MIT device MIT was calculated to about 2.6 kΩ based on the above voltage values.

The resistance of the abrupt MIT device MIT after an abrupt MIT may be controlled by adequately changing the material and structure of the abrupt MIT device MIT. Due to the control of the resistance of the abrupt MIT device MIT, the ratio of a voltage dropped in the abrupt MIT device MIT to a voltage dropped in the protecting resistor Rₚ can be adequately controlled to answer the usage purpose.

To ascertain the characteristics of the circuit of FIG. 10 when a load corresponding to an electrical and/or electronic system is connected thereto, the following experiments were made, in which the resistance of the equivalent load resistor R_{L} was set to 10 kΩ.

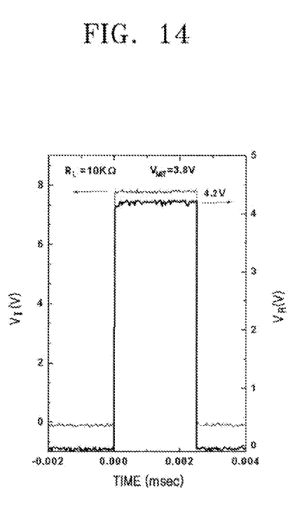

FIG. 13 is a graph showing a relationship between the power voltage V_{I} and the voltage V_{R} dropping at the protecting resistor Rₚ before occurrence of an abrupt MIT when the equivalent load resistor R_{L} in the circuit of FIG. 10 was is 10 kΩ. Referring to FIG. 13, when a power voltage V_{I} of 200 kHz and 4V was applied, the voltage V_{R} dropping at the protecting resistor Rₚ was 0.34 V, and the voltage V_{MIT} dropping at the abrupt MIT device MIT was 3.66 V. In this case, the current flowing in the equivalent load resistor R_{L} was calculated to 0.4 mA, and the current flowing in the abrupt MIT device MIT was calculated to 0.11 mA. Accordingly, about 4 times greater than the current flowing toward the abrupt MIT device MIT flows toward the equivalent load resistor 300.

FIG. 14 is a graph showing a relationship between the power voltage V_{I} and the voltage V_{R} dropping at the protecting resistor Rₚ after occurrence of an abrupt MIT when the equivalent load resistor R_{L} in the circuit of FIG. 10 was is 10 kΩ. Referring to FIG. 14, when a power voltage V_{I} of 200 kHz and 8V was applied, the voltage V_{R} dropping at the protecting resistor Rₚ was 4.2 V, and the voltage W_{MIT} dropping at the abrupt MIT device MIT was 3.8V.

The currents flowing in the equivalent load resistor R_{L} and the abrupt MIT device MIT was able to be calculated using the above-described dropping voltage values. The currents flowing in the equivalent load resistor R_{L} was calculated to 0.8 mA, and the current flowing in the abrupt MIT device MIT was calculated to 1.4 mA. accordingly, the resistance of the abrupt MIT device MIT was 32 kΩ before an MIT, but it became about 2.7 kΩ after an MIT.

Considering the characteristics of general metals, the 2.7 kΩ resistance of the abrupt MIT device MIT obtained after an MIT is not small. However, the resistance of the abrupt MIT device MIT is not fixed but may be controlled by changing the structure and material of the abrupt MIT device MIT. In addition, a composite resistance can be significantly reduced by connecting several abrupt MIT devices MIT each having a high resistance to each other in parallel. In some cases, the composite resistance can bee reduced to 2Ω or less.

For example, when the abrupt MIT device MIT has a resistance less than or equal to 2Ω, a flow of overcurrent in an electrical and/or electronic system represented as the equivalent load resistor R_{L} having a 10 kΩ resistance can be prevented by bypassing most of the current greatly increased due to external noise to go toward the abrupt MIT device MIT.

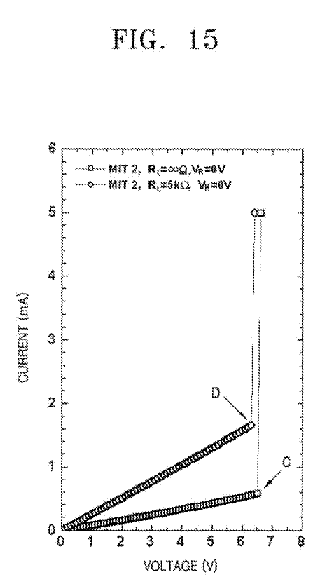

FIG. 15 is a graph showing a current-voltage curve when an equivalent load resistor exists in the circuit of FIG. 10 and that when no equivalent load resistors exist in the circuit of FIG. 10, the two current-voltage curves obtained when no protecting resistors Rₚ are included in the circuit of FIG. 10. The circuit used in the experiment of FIG. 15 uses an abrupt MIT device MIT2 which is formed of vanadium oxide and has a limit voltage different from the 5.5V limit voltage of the abrupt MIT device MIT shown in FIG. 10.

Referring to FIG. 15, the voltage V_{R} was 0V because the protecting resistor Rₚ of the abrupt MIT device MIT was removed from the circuit of FIG. 10. When the equivalent load resistor R_{L} exists in the circuit of FIG. 10, namely, in the case indicated by a rectangle where R_{L} was 5 kΩ, an abrupt MIT occurred at a location of about 6.5V, that is, location C, and thus current abruptly increased up to 5 mA. On the other hand, when no equivalent load resistors R_{L} exist in the circuit of FIG. 10, namely, in the case indicated by a circle where R_{L} was ∞Ω, since current flows only toward the abrupt MIT device MIT, the current increased with an inclination steeper than the current curve in the case indicated by the rectangle and increased abruptly up to 5 mA at a location of about 6.3V, that is, location D.

A difference between current at the location D, where current rapidly increased when no equivalent load resistors R_{L} exist in the circuit of FIG. 10, and current at the location C, where current rapidly increased when the equivalent load resistor R_{L} exists in the circuit of FIG. 10, was about 1 mA. A current as much as the current difference flowed into the equivalent load resistors R_{L}. The current difference was ⅕ of the current flowing in the abrupt MIT device MIT after an abrupt MIT. In the experiment of FIG. 15, the current was limited to 5 mA to protect the abrupt MIT device MIT. In practice, current of 50 mA or more flows.

It can be seen from FIG. 15 that current mostly flows toward the MIT device at or after 6V. Accordingly, an electrical and/or electronic system corresponding to the equivalent load resistors R_{L} is protected from external overvoltage.

In the above-described embodiments, the abrupt MIT device is manufactured such that it has a resistance of several hundreds to several thousands of Ω after its electrical characteristic changes from a characteristic of an insulator to a characteristic of a metal. However, the abrupt MIT device may be manufactured such that it has a resistance of several Ω. Hence, the electrical and/or electronic system can be protected from a received high-voltage, high-frequency noise signal by matching the current and voltage of the abrupt MIT device with a limit current and a limit voltage of the electrical and/or electronic system.

As described above, an electrical and/or electronic system protecting circuit according to the present invention uses an abrupt MIT device to bypass toward the abrupt MIT device most of the noise current generated when the voltage greater than the rated standard voltage is applied, thereby protecting an electrical and/or electronic system. The electrical and/or electronic system protecting circuit may be applied to all sorts of electronic devices, electrical components, electric and electronic systems, and noise filters for protecting high-voltage electrical systems.

In addition, the abrupt MIT device is very simple and low-priced and can be manufactured easily. Therefore, the electrical and/or electronic system protecting circuit using the abrupt MIT device can also be manufactured easily with a low cost.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An electrical and/or electronic system protecting circuit comprising an abrupt metal-insulator transition (MIT) device connected in parallel to an electrical and/or electronic system to be protected from noise.

2. The electrical and/or electronic system protecting circuit of claim 1, wherein:
the noise is received via a power line which applies a power voltage to the electrical and/or electronic system; and
the abrupt metal-insulator transition device is connected to the power line.

3. The electrical and/or electronic system protecting circuit of claim 2, wherein the abrupt metal-insulator transition device is connected to the power line via a protecting resistor which protects the abrupt metal-insulator transition device.

4. The electrical and/or electronic system protecting circuit of claim 2, further comprising a power voltage reinforcing capacitor connected in parallel to a power voltage source which supplies the power voltage to the electrical and/or electronic system.

5. The electrical and/or electronic system protecting circuit of claim 1, wherein:
the noise is received via a signal line which receives a signal from and outputs the signal to the electrical and/or electronic system; and
the abrupt metal-insulator transition device is connected to the signal line.

6. The electrical and/or electronic system protecting circuit of claim 5, wherein the abrupt metal-insulator transition device is connected to the signal line via the protecting resistor which protects the abrupt metal-insulator transition device.

7. The electrical and/or electronic system protecting circuit of claim 1, wherein:
the noise is received via the power line which applies the power voltage to the electrical and/or electronic system and via the signal line which receives the signal from and outputs the signal to the electrical and/or electronic system; and
the abrupt metal-insulator transition device is connected to the power line and the signal line.

8. The electrical and/or electronic system protecting circuit of claim 7, wherein the abrupt metal-insulator transition device is connected to the power line and the signal line via the protecting resistor which protects the abrupt metal-insulator transition device.

9. The electrical and/or electronic system protecting circuit of claim 7, further comprising a power voltage reinforcing capacitor connected in parallel to the power voltage source which supplies the power voltage to the electrical and/or electronic system.

10. The electrical and/or electronic system protecting circuit of claim 1, wherein electrical characteristics of the abrupt metal-insulator transition device abruptly change according to a voltage level of the noise.

11. The electrical and/or electronic system protecting circuit of claim 1, wherein the abrupt metal-insulator transition device has a characteristic of an insulator below a predetermined limit voltage and has a characteristic of a metal at or over the limit voltage.

12. The electrical and/or electronic system protecting circuit of claim 11, wherein the electrical and/or electronic system is protected from noise with a voltage equal to or greater than the limit voltage.

13. The electrical and/or electronic system protecting circuit of claim 1, further comprising at, least one abrupt metal-insulator transition device connected in parallel to the abrupt metal-insulator transition device.

14. An electrical and/or electronic system protecting circuit comprising an abrupt metal-insulator transition device that is connected in parallel to an electrical and/or electronic system to be protected from noise and includes an abrupt metal-insulator transition thin film containing low-concentration holes and a first electrode thin film and a second electrode thin film that contact the abrupt metal-insulator transition thin film.

15. The electrical and/or electronic system protecting circuit of claim 14, wherein:
the noise is received via a power line which applies a power voltage to the electrical and/or electronic system or a signal line which receives a signal from and outputs the signal to the electrical and/or electronic system; and
the abrupt metal-insulator transition device is connected to the power line or the signal line.

16. The electrical and/or electronic system protecting circuit of claim 15, wherein the abrupt metal-insulator transition device is connected to the power line or the signal line via a protecting resistor which protects the abrupt metal-insulator transition device.

17. The electrical and/or electronic system protecting circuit of claim 15, further comprising a power voltage reinforcing capacitor connected in parallel to a power voltage source which supplies the power voltage to the electrical and/or electronic system.

18. The electrical and/or electronic system protecting circuit of claim 14, wherein:
the noise is received via the power line which applies the power voltage to the electrical and/or electronic system and via the signal line which receives the signal from and outputs the signal to the electrical and/or electronic system; and
the abrupt metal-insulator transition device is connected to the power line and the signal line.

19. The electrical and/or electronic system protecting circuit of claim 18, wherein the abrupt metal-insulator transition device is connected to the power line and the signal line via the protecting resistor which protects the abrupt metal-insulator transition device.

20. The electrical and/or electronic system protecting circuit of claim 14, wherein electrical characteristics of the abrupt metal-insulator transition device abruptly change according to a voltage level of the noise.

21. The electrical and/or electronic system protecting circuit of claim 14, wherein the abrupt metal-insulator transition device has a characteristic of an insulator below a predetermined limit voltage and has a characteristic of a metal at or over the limit voltage.

22. The electrical and/or electronic system protecting circuit of claim 14, wherein the abrupt metal-insulator transition thin film is formed of at least one material selected from the group consisting of an inorganic semiconductor to which low-concentration holes are added, an inorganic insulator to which low-concentration holes are added, an organic semiconductor to which low-concentration holes are added, an organic insulator to which low-concentration holes are added, a semiconductor to which low-concentration holes are added, an oxide semiconductor to which low-concentration holes are added, and an oxide insulator to which low-concentration holes are added, wherein the above-described materials each include at least one of oxygen, carbon, a semiconductor element (i.e., groups III-V and groups II-IV), a transition metal element, a rare-earth element, and a lanthanum-based element.

23. The electrical and/or electronic system protecting circuit of claim 14, wherein each of the first and second electrode thin films is formed of at least one material selected from the group consisting of W, Mo, W/Au, Mo/Au, Cr/Au, Ti/W, Ti/Al/N, Ni/Cr, Al/Au, Pt, Cr/Mo/Au, YB₂Cu₃O_{7-d}, Ni/Au, Ni/Mo, Ni/Mo/Au, Ni/Mo/Ag, Ni/Mo/Al, Ni/W, Ni/W/Au, Ni/W/Ag, and Ni/W/Al.

24. The electrical and/or electronic system protecting circuit of claim 14, wherein the abrupt metal-insulator transition thin film is formed of an n-type semiconductor-insulator.

25. The electrical and/or electronic system protecting circuit of claim 14, wherein the abrupt metal-insulator transition device comprises:
a substrate;
a first electrode thin film formed on the substrate;
an abrupt metal-insulator transition thin film formed on the first electrode thin film, including low-concentration holes; and
a second electrode tin film formed on the abrupt metal-insulator transition thin film.

26. The electrical and/or electronic system protecting circuit of claim 25, where the abrupt metal-insulator transition device further comprises a buffer layer formed between the substrate and the first electrode thin film.

27. The electrical and/or electronic system protecting circuit of claim 26, wherein the buffer layer comprises a film formed of one of SiO₂ and Si₃N₄.

28. The electrical and/or electronic system protecting circuit of claim 14, wherein:
the abrupt metal-insulator transition device comprises:
a substrate;
an abrupt metal-insulator transition thin film formed on a part of the upper surface of the substrate, including low-concentration holes;
a first electrode thin film formed on an exposed part of the upper surface of the substrate, one lateral surface of the abrupt metal-insulator transition thin film, and a part of the upper surface of the abrupt metal-insulator transition thin film; and
a second electrode tin film formed on the remaining exposed part of the upper surface of the substrate, the other lateral surface of the abrupt metal-insulator transition thin film, and a part of the upper surface of the abrupt metal-insulator transition thin film such as to face the first electrode thin film; and
the first and second electrode thin films are separated from each other.

29. The electrical and/or electronic system protecting circuit of claim 28, where the abrupt metal-insulator transition device further comprises a buffer layer formed on the substrate.

30. The electrical and/or electronic system protecting circuit of claim 29, wherein the buffer layer comprises a film formed of one of SiO₂ and Si₃N₄.

31. The electrical and/or electronic system protecting circuit of claim 25, wherein the substrate is formed of at least one material selected from the group consisting of Si, SiO₂, GaAs, Al₂O₃, plastic, glass, V₂O₅, PrBa₂Cu₃O₇, YBa₂Cu₃O₇, MgO, SrTiO₃, Nb-doped SrTiO₃, and silicon-on-insulator (SOI).

32. The electrical and/or electronic system protecting circuit of claim 14, further comprising at least one abrupt metal-insulator transition device connected in parallel to the abrupt metal-insulator transition device.

33. An electrical and/or electronic system comprising:
a load electric and electronic system to be protected from noise; and
an electrical and/or electronic system protecting circuit including an abrupt metal-insulator transition device connected in parallel to the load electrical and/or electronic system.

34. The electrical and/or electronic system of claim 33, further comprising a power voltage source which applies a power voltage to the load electrical and/or electronic system via a power line,
wherein the noise is applied to the load electrical and/or electronic system via the power line, and the abrupt metal-insulator transition device of the electrical and/or electronic system protecting circuit is connected to the power line.

35. The electrical and/or electronic system of claim 34, wherein the abrupt metal-insulator transition device of the electrical and/or electronic system protecting circuit is connected to the power line via a protecting resistor which protects the abrupt metal-insulator transition device.

36. The electrical and/or electronic system of claim 34, further comprising a power voltage reinforcing capacitor connected in parallel to the power voltage source.

37. The electrical and/or electronic system of claim 33, further comprising a signal source which receives a signal from and outputs the signal to the load electrical and/or electronic system via a signal line,
wherein:
the noise is applied to the load electrical and/or electronic system via the signal line; and
the abrupt metal-insulator transition device of the electrical and/or electronic system protecting circuit is connected to the signal line.

38. The electrical and/or electronic system of claim 37, wherein the abrupt metal-insulator transition device of the electrical and/or electronic system protecting circuit is connected to the signal line via the protecting resistor which protects the abrupt metal-insulator transition device.

39. The electrical and/or electronic system of claim 33, comprising a power voltage source which applies a power voltage via a power line and a signal source which receives a signal from and outputs the signal via a signal line,
wherein the noise is applied to the load electrical and/or electronic system via the power line and the signal line; and
the abrupt metal-insulator transition device of the electrical and/or electronic system protecting circuit is connected to the power line and the signal line.

40. The electrical and/or electronic system of claim 39, wherein the abrupt metal-insulator transition device of the electrical and/or electronic system protecting circuit is connected to the power line and the signal line via a protecting resistor which protects the abrupt metal-insulator transition device.

41. The electrical and/or electronic system of claim 39, further comprising a power voltage reinforcing capacitor connected in parallel to the power voltage source.

42. The electrical and/or electronic system of claim 33, wherein electrical characteristics of the abrupt metal-insulator transition device abruptly change according to a voltage level of the noise.

43. The electrical and/or electronic system of claim 33, wherein the abrupt metal-insulator transition device has a characteristic of an insulator below a predetermined limit voltage and has a characteristic of a metal at or over the limit voltage.

44. The electrical and/or electronic system of claim 43, wherein the load electrical and/or electronic system is protected from noise with a voltage equal to or greater than the limit voltage.

45. The electrical and/or electronic system of claim 33, wherein the electrical and/or electronic system protecting circuit further comprises at least one abrupt metal-insulator transition device connected in parallel to the abrupt metal-insulator transition device.
